(19) United States
(12) Patent Application Publication
(10) Pub. No.: US 2017/0241362 A1
(43) Pub. Date: Aug. 24, 2017

(54) ENGINE CONTROL SYSTEM FOR AN INTERNAL COMBUSTION ENGINE

(71) Applicant: Mahle International GmbH, Stuttgart (DE)

(72) Inventor: Christoph Beerens, Stuttgart (DE)

(21) Appl. No.: 15/439,698

(22) Filed: Feb. 22, 2017

(30) Foreign Application Priority Data
Feb. 23, 2016 (DE) 10 2016 202 770.0

(51) Int. Cl. F02D 41/28; F02B 77/08; H02N 2/18; F02B 63/04

(52) U.S. Cl. CPC F02D 41/28; F02B 63/04; F02B 77/085; H02N 2/186; F02D 2041/281

(57) ABSTRACT

An engine control system for an internal combustion engine may include at least one energy harvesting module with at least one energy converter and at least one energy module for transmitting electric energy, and at least one sensor for detecting a physical or chemical measurement quantity on or in an engine component. The engine control system may also include a microcontroller connected to the sensor and the radio module and for processing the measurement quantity, a radio module for a wireless transmission of the measurement quantity to a radio receiver, and an engine control unit connected to the radio receiver and configured to evaluate incoming measurement quantities from the radio module, process the incoming measurement quantities into control signals, and transmit the control signals to the internal combustion engine for protecting the engine component. The energy module may be connected at least to the microcontroller and the radio module.

This application claims priority to German Application Number DE 10 2016 202 770.0, filed on Feb. 23, 2016, the contents of which are hereby incorporated by reference in its entirety.

### TECHNICAL FIELD

The present invention relates to an engine control system for an internal combustion engine. In addition, the invention relates to an internal combustion engine with such an engine control system and to a method for controlling an internal combustion engine with the aid of such an engine control system.

### BACKGROUND

The term engine control system usually subsumes an engine control unit (electronic control unit, ECU), which assumes the open-loop control, closed-loop control and monitoring of functions of an internal combustion engine as a function of measurement quantities determined by sensors, which are evaluated and processed in the engine control unit. In modern engine control systems, efficient, digital microprocessors or microcontrollers are employed for this purpose, which in addition to the internal combustion engine processes in the internal combustion engine can also control further functions in particular functions beyond that. These include in particular a fuel injection, an ignition, a charge pressure closed-loop control, a closed-loop control of the idle rotational speed and an activation of a throttle valve.

Usually, the individual components of the engine control systems require electric energy for operation, which is made available via suitable cables from an electric energy storage unit, for example a vehicle battery. However it is exactly this cabling that proves increasingly difficult or in some parts even impossible with sensors that become ever smaller and the desire to also detect internal measurement quantities of an internal combustion engine. The cabling required up to now in this case does not only increase an assembly expenditure and thus indirectly the production costs, but also requires additional material, causing the material costs to rise. In addition to this, such a cabling, in particular of extremely small sensors of an engine control system, has to be also installed protected because of the temperature and moisture conditions that are present in an engine compartment of a motor vehicle, resulting in further costs.

### SUMMARY

The present invention therefore deals with the problem of stating an improved or at least an alternative embodiment for an engine control unit of the generic type, which in particular overcomes the disadvantages know from the prior art.

According to the invention, this problem is solved through the subject of the independent claims. Advantageous embodiments are subject of the dependent claims.

The present invention is based on the general idea of using for the first time no external energy supply for supplying parts of an engine control system with electric energy but to make use of the principal of the so-called energy harvesting, in the case of which in particular smaller quantities of electric energy are extracted from sources such as for example a temperature of an internal combustion engine, vibrations or air flows. By such harvesting of the energy of components which give off energy anyhow it is not only possible to lower the energy expenditure to be made available externally, but cabling expenditure that is required up to now can also be significantly reduced, in particular when between individual components of the engine control system a wireless data transmission is additionally established. The engine control system for an internal combustion engine according to the invention in this case comprises at least one energy harvesting module, which comprises at least one energy converter and at least one energy module. Likewise, the engine control system according to the invention comprises at least one sensor for detecting a physical or a chemical measurement quantity on or in an engine component of the internal combustion engine, a microcontroller for processing the detected measurement quantity and a radio module for the wireless transmission of the measurement quantities processed by the microcontroller to a radio receiver. The microcontroller and the radio module can also be a component, a so-called system-on-a-chip (SOC). Here, the microcontroller is communicatingly connected by wiring both to the sensor and also to the radio module, wherein the energy module for transmitting electric energy is at least connected to the microcontroller and the radio module. Externally arranged is an engine control unit which is connected to the radio receiver and to at least the internal combustion engine and at the same time is designed in such a manner that it evaluates measurement quantities coming in from the radio receiver, processes these into the control signal and transmits these to the internal combustion engine for the control of the same. With the engine control system according to the invention it is thus possible for the first time to convert heat, movement or pressure energy radiated for example from the internal combustion engine or its components with the help of the energy converter into electric energy and moreover assume the electric energy supply of the microcontroller and of the radio module and if applicable—insofar as required—of the sensor. Expensive cabling of the sensor with for example a vehicle battery in particular can be entirely omitted because of this, as a result of which an independent arrangement of the at least one sensor in locations that were not accessible for a cable-based connection is also possible. The engine control system according to the invention thus makes it possible for the first time to open up installation spaces that could not be exploitable in the past using electrical cables for arranging sensors, but also to increase the efficiency of the internal combustion engine since for the electric energy supply of the engine control system, in particular of the radio microcontroller, energy of the internal combustion engine which was given off into the surroundings in the past is utilised for the first time. Here, it is not the energy generated in the combustion chamber of the internal combustion engine that is utilised but rather vibrations or other kinetic energy which accrues the movement of the internal combustion engine/engine components or thermal energy of other engine components such as for example a radiator, a condenser, an exhaust gas turbocharger, an exhaust gas line, etc. In an advantageous further development of the solution according to the invention, the at least one sensor is arranged in a piston, a connecting rod, a valve, an engine block, in particular in a cylinder wall of the engine block, a bearing, of a camshaft or of a crankshaft of the internal combustion engine. Even this incomplete enumeration gives an idea of the manifold new installation spaces or arrangement possibilities for such sensors of the engine control system according to the invention that are possible. In the case of an arrangement of such a sensor in a connecting rod, pressure forces of the piston can be detected for example.

In an advantageous further development of the solution according to the invention, the at least one sensor is designed for detecting a temperature, a force and/or a pressure. This likewise incomplete enumeration provides a rough overview of the possibilities for detecting physical and/or chemical quantities by the at least one sensor.

In a further advantageous embodiment of the solution according to the invention, the energy module is designed for smoothing an electric voltage received from the at least one energy converter. Since the energy converter under certain conditions cannot generate and transmit a continuous energy supply, in particular no uniform voltage, it is required for a reliable and in particular also even energy supply of the microcontroller and/or of the radio module to homogenise the incoming electric energy from the energy converter, in particular to smooth the electric voltage.

Practically, the energy converter is designed for converting temperature, vibrations, flows, in particular air flows and/or pressure into electric energy. This makes possible an almost unlimited arrangement possibility of the energy converter on or in the internal combustion engine, for example in the region of an engine block, on which the energy converter converts the heat energy that occurs in the engine block into electric energy and passes it on to the energy module of the energy harvesting module, which for example smoothes the incoming electric voltage and supplies the microcontroller and the radio controller with electric energy. Here, the energy converter can be designed for example as a so-called Peltier element, i.e. as electrothermic converter, which based on the so-called Peltier effect generates a current flow in the case of a temperature differential. Purely theoretically it is obviously also conceivable that the energy converter converts the vibrations/movements that occur on the engine block or on the connecting rod into electric energy. On the whole, the efficiency of the internal combustion engine can be improved because of this.

Preferentially, the energy that is present in the combustion chamber is not directly utilised during the energy extraction. This is to be used exclusively for generating the drive power of the internal combustion engine. The energy harvesting should rather take place via kinetic energy from the kinematics or dynamics of the internal combustion engine. For example, the pivot movement of a connecting rod could be used for this purpose in order to generate electric energy via Piezo elements. Thermal energy, for example from the cooling system, which no longer serves for generating drive power, can also be used for generating electric energy. During the harvesting of electric energy on individual components, these can for example also be cooled and because of this protected from temperature-related damage.

Furthermore, the present invention is based on the general idea of stating a method for controlling an internal combustion engine, with which the previously described control system is employed. In the method according to the invention, heat, movements, vibrations or flows, for example air flows, of the internal combustion engine are initially converted into electric energy by means of the previously described energy converter of an energy harvesting module transmitting it to an energy module of the energy harvesting module which in turn again supplies the microcontroller and the radio module with electric energy and because of this makes possible their operation. By means of the at least one sensor, a physical or chemical measurement quantity of the internal combustion engine is detected at the same time and transmitted to the microcontroller which processes the detected measurement quantity and transmits the same to the radio module which wirelessly transmits the processed measurement quantity to an externally arranged radio receiver which in turn passes on the measurement quantity to an engine control unit. This likewise externally arranged engine control unit evaluates the received measurement quantities, processes these and because of this generates a control signal which it transmits to the internal combustion engine and thereby controls the same. Because of this, a pre-ignition, for example by way of a sensor detecting temperature differentials or pressure can thereby be detected and in particular suitable measures be taken, for example by way of a fuel injection or similar for cooling or mixture variation. In addition to this it is also conceivable that by means of the at least one sensor, pressures or forces on a bearing, for example on a connecting rod bearing can be detected in order to thereby make possible a combustion synchronisation and in particular an even operation of the internal combustion engine. Here, the forces can be measured on all cylinders and for example the injection quantity subsequently adapted.

In an advantageous further development of the solution according to the invention, the at least one sensor detects a temperature, a force and/or a pressure. This incomplete enumeration already gives a rough overview of the manifold possibility of detection that is available by means of the at least one sensor, whereby the detected chemical and/or physical parameters allow drawing conclusions regarding the operation of the internal combustion engine. In particular, a temperature in a combustion chamber of a cylinder, a force in a connecting rod of the internal combustion engine and/or a pressure can thereby be detected in particular.

Further important features and advantages of the invention are obtained from the subclaims, from the drawings and from the associated figure description by way of the drawings.

It is to be understood that the features mentioned above and the features still to be explained in the following cannot only be used in the respective combination stated but also in other combinations or by themselves without leaving the scope of the present invention.

Preferred exemplary embodiments of the invention are shown in the drawings and are explained in more detail in the following description wherein same reference numbers relate to same or similar or functionally same components.

### BRIEF DESCRIPTION OF THE DRAWINGS

It shows, in each case schematically,

FIG. 1 an engine control system according to the invention for an internal combustion engine, in particular of a motor vehicle,

FIG. 2 a detail representation of the engine control system according to FIG. 1.

### DETAILED DESCRIPTION

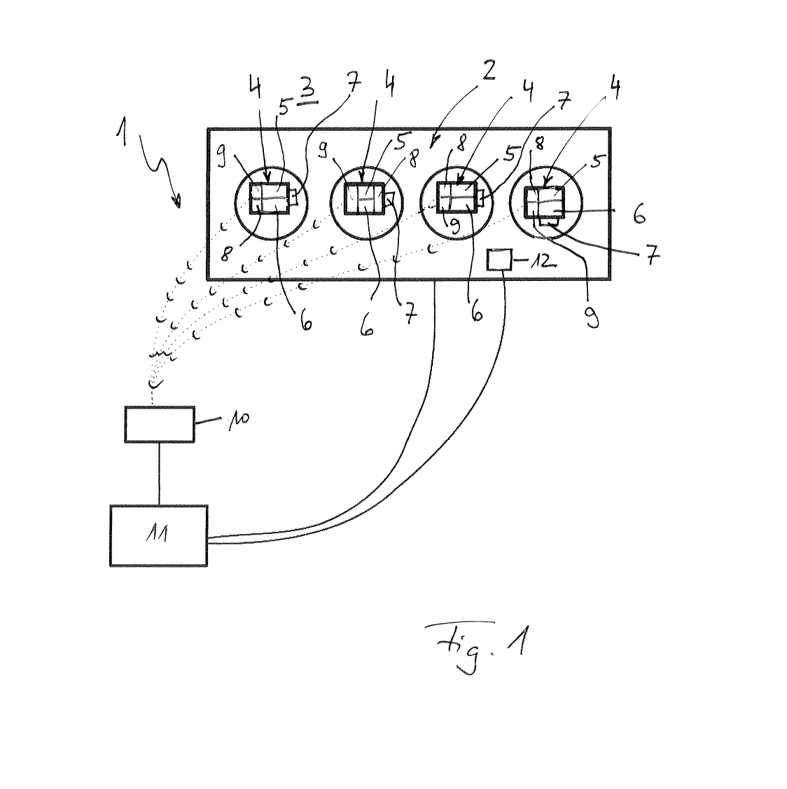

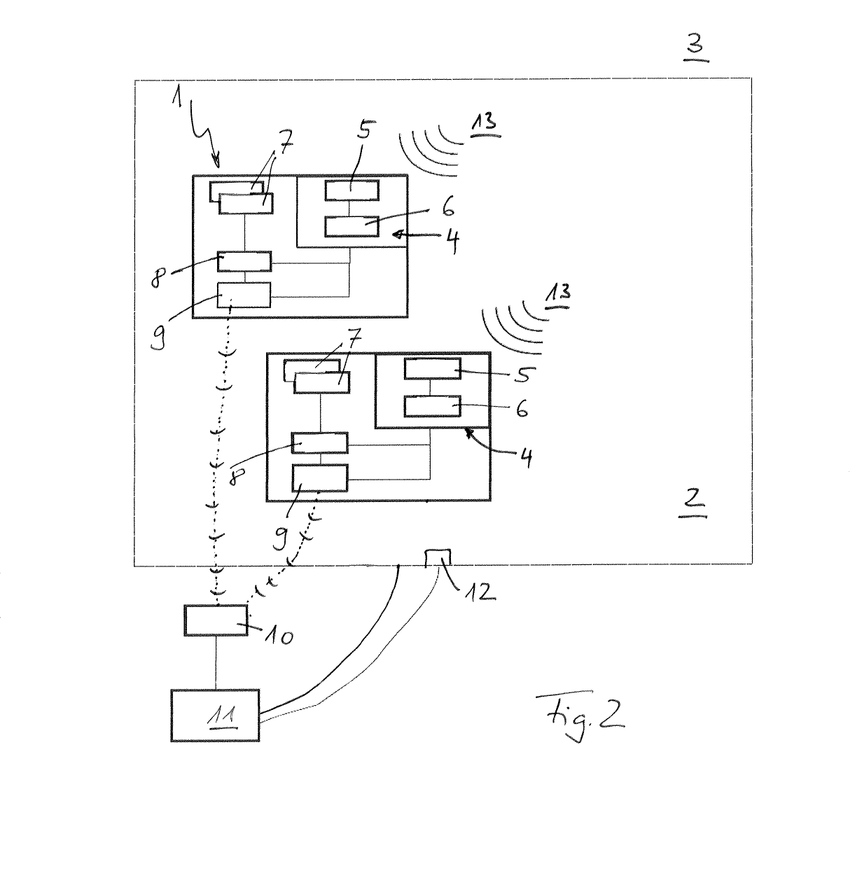

According to FIGS. 1 and 2, an engine control system 1 according to the invention for an internal combustion engine 2, in particular in a motor vehicle 3 comprises at least one energy harvesting module 4 which has at least one energy converter 5 and at least one energy module 6 (see FIG. 2). Likewise provided is at least one sensor 7, according to FIG. 2 even two sensors 7 in each case for detecting a physical or a chemical measurement quantity on or in an (engine) component 13 of the internal combustion engine 2, a microcontroller 8 for processing the detected measurement quantity and a radio module 9 for wirelessly transmitting the measurement quantity (quantities) processed by the microcontroller 8 to an external radio receiver 10. According to FIGS. 1 and 2, wireless transmission paths are shown with dotted, i.e. interrupted line while wire-based transmission paths both for data and also for energy are shown using continuous lines. Here, it is not the energy that is generated in the combustion chamber of the internal combustion engine 2 that is utilised but rather vibrations or other kinetic energy, which is accrued during the movement or during the operation of the engine components 13 or thermal energy of other engine components 13, such as for example a radiator, a condenser, an exhaust gas turbocharger, an exhaust gas line etc. Furthermore, the microcontroller 8, in the case of the engine control system 1 according to the invention, is communicatingly connected to the at least one sensor 7, according to FIG. 2 to the two sensors 7 and the radio module 9, wherein the energy module 6 of the energy harvesting module 4 for transmitting electric energy is connected at least to the microcontroller 8 and the associated radio module 9. Externally arranged is an engine control unit 11, which is connected to the radio receiver 10 and at the same time designed in such a manner that it evaluates incoming measurement quantities from the radio receiver 10, processes these into control signals and transmits these to the internal combustion engine 2 for controlling the same or to the engine components 13 for protecting the same.

In addition to this, a further sensor 12 can be provided which is connected by wiring to the engine control unit 11, in particular arranged in its vicinity on the internal combustion engine 2 and transmits further measurement quantities for controlling the internal combustion engine 2 to the engine control unit 11.

The at least one sensor 7 for detecting a physical and/or chemical measurement quantity of the internal combustion engine 2 and/or on an engine component 13 of the internal combustion engine 2 can be in particular arranged in a piston, a connecting rod, a valve, an engine block, in particular of a cylinder wall of the engine block, a bearing, in particular of a connecting rod bearing, a camshaft or a crankshaft of the internal combustion engine 2. Even this incomplete enumeration shows the manifold arrangement possibilities of the at least one sensor 7 or of the sensors 7, as a result of which a preferentially complete monitoring of the internal combustion engine 2 with respect to significant measurement quantities that occur there is possible. The at least one sensor 7 is designed for detecting a temperature, a position of a component, of a force and/or of a pressure but purely theoretically also capable alternatively to analyse chemical compositions and transmit an analysis result resulting from this to the microcontroller 8 for example a processor.

Viewing the energy harvesting module 4 according to FIGS. 1 and 2, the same substantially consists of the energy converter 5 and the energy module 6, wherein the energy converter 5 is designed for example for converting temperature, vibrations, flows, in particular air flows and/or pressures into electric energy. Because of this it is possible to use energy that is present on the internal combustion engine 2 or on engine components 13 anyway and given off by the same, which up to now is discharged or given off to the environment unutilised, and to utilise the same for the first time for the electric energy extraction and thereby supply both the microcontroller 8 and also at least the radio module with energy. In the same manner, an electric energy supply of at least one sensor 7 is also obviously conceivable. In particular, such an energy converter 5 can be designed for example as a Peltier element, which utilises a heat differential for generating an electric current. Such a Peltier element can be arranged for example on the engine block of the internal combustion engine 2, on an exhaust gas line or on a radiator and utilise the energy radiated by the same into the environment for generating electric energy. Since the energy converter 5 under certain conditions, in particular insofar as the same converts vibrations and/or pressures into electric energy, cannot bring about an even energy supply, the energy module 6 of the energy harvesting module 4 is preferentially designed for smoothing an electric voltage received from the at least one energy converter 5. The energy harvesting module 4, i.e. the energy converter 5 installed therein and the energy module 6 contained therein as well as the microcontroller 8 and the radio module 9 as well as the sensors 7 are wired, as is the engine control unit 11 and the internal combustion engine 2 or the engine control unit 11 and the further sensor 12 on the internal combustion engine 2.

Generally, the internal combustion engine 2 is controlled by means of the engine control system 1 by means of the invention as follows:

During the operation of the internal combustion engine 2, the at least one energy converter 5 of the energy harvesting module 4 converts heat, vibrations or flows, in particular air flows, of the internal combustion engine 2 or of an engine component 13 into electric energy and thereby supplies the energy module 6 of the energy harvesting module 4 with electric energy. In the process, the energy in the combustion chamber of the internal combustion engine 2 is preferentially not directly accessed, but rather movement energy or thermal energy of engine components 13 interacting with the internal combustion engine 2. In the energy module 6, the voltage generated by the energy converter 5 is preferentially smoothed, i.e. homogenised, so that as continuous as possible a voltage supply for the microcontroller 8 and the radio module 9 can be made available. In the same manner it is also conceivable that the at least one sensor 7, provided the same requires this, is supplied with a smoothed voltage as electric energy from the energy module 6. The at least one sensor 7 in the process detects at least one physical and/or chemical measurement quantity on or in a component 13 of the internal combustion engine 2 and transmits the same to the microcontroller 8, which processes the detected measurement quantity and transmits it to the radio module 9. This is preferentially effected by wiring. The wire-based sections between energy harvesting module 4, microcontroller 8, sensor 7 and radio module 9 in this case are preferentially very short, wherein it is even conceivable that these components form a very small contiguous unit.

The radio module 9 now transmits the processed measurement quantity received from the microcontroller 8 wirelessly, i.e. by means of radio, to an externally arranged radio receiver 10 which receives the radio signal and passes the measurement quantity contained therein on to the engine control unit 11. In this engine control unit 11, the measurement control unit is evaluated, processed and subsequently the internal combustion engine 2 controlled as a function of the measurement quantity. Controlling the internal combustion engine 2 in this case can obviously be effected not only as a function of the measurement quantities detected by the sensors 7 but further sensors 12 can also be directly connected to the internal combustion engine 2 but which are then connected by wire to the engine control unit 11, as is evident according to FIGS. 1 and 2.

Generally, the sensors 7 or the at least one sensor 7 are/is able to detect internal measurement quantities of the internal combustion engine 2 such as for example bearing pressures and temperatures, connecting rod forces, cylinder pressures, temperatures etc. The sensor 7 can also be designed as a knocking sensor. In particular by detecting the forces in the connecting rods a possible intervention regarding a synchronisation of the combustion in the internal combustion engine 2 is obtained because of this. Here, the forces can be measured on all cylinders and for example the injection quantity matched accordingly.

Preferentially, the signal evaluation at least of a major part, preferentially even entirely in the microcontroller 8, which is supplied with electric energy from the energy harvesting module 4, as a result of which a comparatively energy-intensive data transmission via the radio section between the radio module 9 and the externally arranged radio receiver 10 has to be established preferentially only temporary and briefly. Because of the energy-independent operation of the sensors 7, of the microcontroller 8 and of the radio module 9, these can also be arranged in locations where cabling in the past was difficult or not possible at all.

With the method according to the invention, a pre-ignition can be detected, in particular, for example by sensors 7, which detect a temperature and/or a pressure and initiate suitable measures for example a corresponding fuel injection or similar for cooling or a change in mixture.

Generally it is possible with the engine control system 1 according to the invention and the internal combustion engine 2 according to the invention and with the method according to the invention to avoid restrictions during a wireless data transmission through wire-based power supplies or batteries. Via the energy converters 5 of the respective energy harvesting modules 4 the engine control system 1 according to the invention utilises for the first time energy that is present on the internal combustion engine 2 anyway and has been given off to the environment unutilised in the past. Because of this, the efficiency of the internal combustion engine 2 according to the invention can be (at least slightly) improved and in particular a reduction of the pollutant emissions be at least indirectly achieved through a lower fuel consumption which on the one hand results from the utilisation of previously unutilised energy sources and on the other hand through a significantly energy control through a significantly more accurate picking off of physical and/or chemical quantities, in particular in the combustion process.

Generally it is additionally possible with the engine control system 1 according to the invention and the internal combustion engine 2 according to the invention as well as with the method according to the invention to closed-loop control the internal combustion engine 2, in particular provided that the engine control unit 11 is designed as an engine closed-loop control unit. For example, the sensor 7 can be designed as a knocking sensor, i.e. as a structure-borne sensor, the signal of which is analysed with the help of electronic filters and the microcontroller 8 for the high-frequency vibration constituents typical for the knocking. When such signals are detected, a corresponding open-loop control/closed-loop control of the internal combustion engine 2 could be effected by way of the engine open-loop control unit/closed-loop control unit 11.

1. An engine control system for an internal combustion engine, comprising:
at least one energy harvesting module with at least one energy converter and at least one energy module for transmitting electric energy;
at least one sensor for detecting one of a physical and a chemical measurement quantity one of on and in an engine component of the internal combustion engine;
a microcontroller for processing the detected measurement quantity;
a radio module for a wireless transmission of the measurement quantity processed by the microcontroller to a radio receiver; and
an engine control unit communicatingly connected to the radio receiver, the engine control unit configured to evaluate incoming measurement quantities from the radio module, process the incoming measurement quantities into control signals, and transmit the control signals to the internal combustion engine for protecting the engine component;
wherein the microcontroller is communicatingly connected to the sensor and the radio module, and the energy module.

2. The engine control system according to claim 1, wherein the at least one sensor is arranged in one of a piston, a valve, an engine block, a bearing, a camshaft and a crankshaft of the internal combustion engine.

3. The engine control system according to claim 1, wherein the at least one sensor is designed for detecting at least one of a temperature, a force, and a pressure.

4. The engine control system according to claim 1, wherein the energy module is designed for smoothing an electric voltage received from the at least one energy converter.

5. The engine control system according to claim 1, wherein the at least one energy converter is designed for converting at least one of temperature, vibrations, flows, and pressure into electric energy.

6. The engine control system according to claim 1, wherein at least one of:
the at least one sensor, the at least one energy converter, the at least one energy module, the microcontroller and the radio module are wire-based in that the engine control unit and the radio receiver are wire-based; and
the engine control unit and the radio reciever are wire-based.

7. An internal combustion engine comprising an engine control system having:
at least one energy harvesting module with at least one energy converter and at least one energy module for transmitting electric energy;
at least one sensor for detecting one of a physical and a chemical measurement quantity one of on and in an engine component of the internal combustion engine;
a microcontroller for processing the detected measurement quantity;
a radio module for a wireless transmission of the measurement quantity processed by the microcontroller to a radio receiver; and
an engine control unit communicatingly connected to the radio receiver, the engine control unit configured to evaluate incoming measurement quantities from the radio module, process the incoming measurement quantities into control signals, and transmit the control signals to the internal combustion engine for protecting the engine component;
wherein the microcontroller is communicatingly connected to the sensor and the radio module, and the energy module is connected at least to the microcontroller and the radio module.

8. A method for controlling an internal combustion engine having an engine control system, comprising:
converting, via at least one energy converter of an energy harvesting module of the engine control system, heat, force, vibrations, and flows of the internal combustion engine into electric energy;
transmitting, via the at least one energy converter, the electric energy into an energy module of the energy harvesting module;
supplying, via the energy module, a microcontroller and a radio module of the engine control system with the electric energy
detecting, via at least one sensor, one of a physical and a chemical measurement quantity one of on and in an engine component of the internal combustion engine;
transmitting the the detected measurement quantity to the microcontroller;
processing, via the microcontroller, the detected measurement quantity;
transmitting the processed measurement quantity to the radio module;
wirelessly transmitting, via the radial module, the processed measurement quantity to a radio receiver;
passing, via the radio receiver, the processed measurement quantity onto an engine control unit of the engine control system;
evaluating, via the engine control unit, the processed measurement quantity;
processing, via the engine control unit, the processed measurement quantity into a control signal; and
transmitting, via the engine control unit the control signal, as a function of the measurement quantity, to the internal combustion engine for protecting the engine component;
wherein the engine control unit is communicatingly connected to the radio receiver, the microcontroller is communicatingly connected to the sensor and the radio module, and the energy module is connected at least to the microcontroller and the radio module.

9. The method according to claim 8, wherein the at least one sensor detects at least one of a temperature, a force, and a pressure.

10. The method according to claim 8, further comprising smoothing, via the energy module, the electric energy received from the energy converter.

11. The method according to claim 9, further comprising smoothing, via the energy module, the electric energy received from the energy converter.

12. The engine control system according to claim 2, wherein the at least one sensor is designed for detecting at least one of a temperature, a force, and a pressure.

13. The engine control system according to claim 2, wherein the energy module is designed for smoothing an electric voltage received from the at least one energy converter.

14. The engine control system according to claim 3, wherein the energy module is designed for smoothing an electric voltage received from the at least one energy converter.

15. The engine control system according to 2, wherein the at least one energy converter is designed for converting at least one of temperature, vibrations, flows, and pressure into electric energy.

16. The engine control system according to 3, wherein the at least one energy converter is designed for converting at least one of temperature, vibrations, flows, and pressure into electric energy.

17. The engine control system according to 4, wherein the at least one energy converter is designed for converting at least one of temperature, vibrations, flows, and pressure into electric energy.

18. The engine control system according to claim 2, wherein at least one of:
the at least one sensor, the at least one energy converter, the at least one energy module, the microcontroller, and the radio module are wire-based; and
the engine control unit and the radio receiver are wire-based.

19. The engine control system according to claim 3, wherein at least one of:
the at least one sensor, the at least one energy converter, the at least one energy module, the microcontroller, and the radio module are wire-based; and
the engine control unit and the radio receiver are wire-based.

20. The engine control system according to claim 4, wherein at least one of:
the at least one sensor, the at least one energy converter, the at least one energy module, the microcontroller, and the radio module are wire-based; and
the engine control unit and the radio receiver are wire-based.
